(19) United States
(12) Patent Application Publication
(10) Pub. No.: US 2018/0074773 A1
(43) Pub. Date: Mar. 15, 2018

(54) DISPLAY SYSTEM SHARED AMONG COMPUTERS

(71) Applicant: EVGA CORPORATION, New Taipei City (TW)

(72) Inventor: Tai-Sheng Han, New Taipei City (TW)

(21) Appl. No.: 15/409,554

(22) Filed: Jan. 19, 2017

(30) Foreign Application Priority Data
Sep. 9, 2016 (TW) 105213952

(51) Int. Cl. G06F 3/14; G06F 3/0488; G06F 3/01

(52) U.S. Cl. CPC G06F 3/1423; G06F 3/017; G06F 3/04883

(57) ABSTRACT

The display system is shared among a number of computers. The display system includes a display device, at least a gesture recognition device, a number of connection ports, a circuit board, a processing unit, and a switch unit. The gesture recognition device and the connection ports are configured along edges of the display device. Each port connects one of the computer and receives video signal from the computer for presentation on the display device. The circuit board is housed inside the display device and data-linked with the connection ports and the gesture recognition device. The circuit board includes a processing unit and a switch unit. A gesture is recognized by the gesture recognition device and the switch unit is controlled to select a video signal from a specific connection port to be presented by the display device.

### BACKGROUND OF THE INVENTION

### (a) Technical Field of the Invention

The present invention is generally related to video switching, and more particular to a display system shared among computers and switching video signals from the computers using gestures.

### (b) Description of the Prior Art

Some advanced users of computers operate multiple computers simultaneously. Therefore there is a need to have a single display device switchable among these computers. Usually a video switch device is adopted to satisfy this need. The video switch device is already common in the market and usually the computers and the display device are all connected to the video switch device. Through the video switch device, a user may choose and control the display device to display the video signal from a specific computer. As such a single display device is shared among the computers.

The above described video switch device has the following shortcomings.

Purchasing the video switch device adds additional financial burden to the user. The installation of the video switch device, especially cabling, is troublesome. Display lagging is not uncommon when the video switch device switches from one computer to another.

### SUMMARY OF THE INVENTION

Therefore a novel display system is provided where the display system is shared among computers and the video signals from the computers is switched using gestures.

A major objective of the present invention is that simple gestures are used to conveniently select a video signal from a specific computer for presentation on the display device.

Another major objective of the present invention is that, through the configuration of a processing unit, the overhead of the computer in processing video signal is reduced and display smoothness on the display device is enhanced.

The display system includes a display device, at least a gesture recognition device, a number of connection ports, a circuit board, a processing unit, and a switch unit. The gesture recognition device and the connection ports are configured along edges of the display device. Each port connects one of the computer and receives video signal from the computer for presentation on the display device. The circuit board is housed inside the display device and data-linked with the connection ports and the gesture recognition device. The circuit board includes a processing unit and a switch unit. A gesture is recognized by the gesture recognition device and the switch unit is controlled to select a video signal from a specific connection port to be presented by the display device. The present invention also allows that the video signals are combined and shown simultaneously on the display device.

Through the present invention, there is no need to purchase additional switching device and cabling among the display device and the computers is also greatly simplified. Additionally, display lagging due to the computer is overloaded is resolved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a display system according to an embodiment of the present invention.

FIG. 2 is a functional block diagram showing the display system of FIG. 1.

FIG. 3 is a perspective diagram showing an application scenario of the display system of FIG. 1.

FIG. 4 is a perspective diagram showing another application scenario of the display system of FIG. 1.

FIG. 5 is a perspective diagram showing yet another application scenario of the display system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

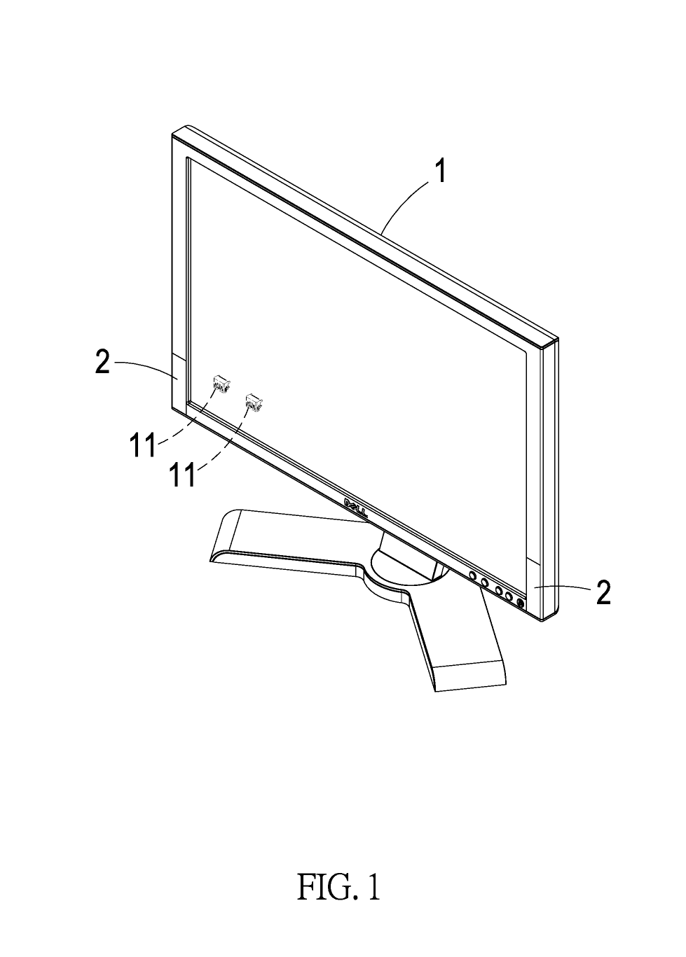

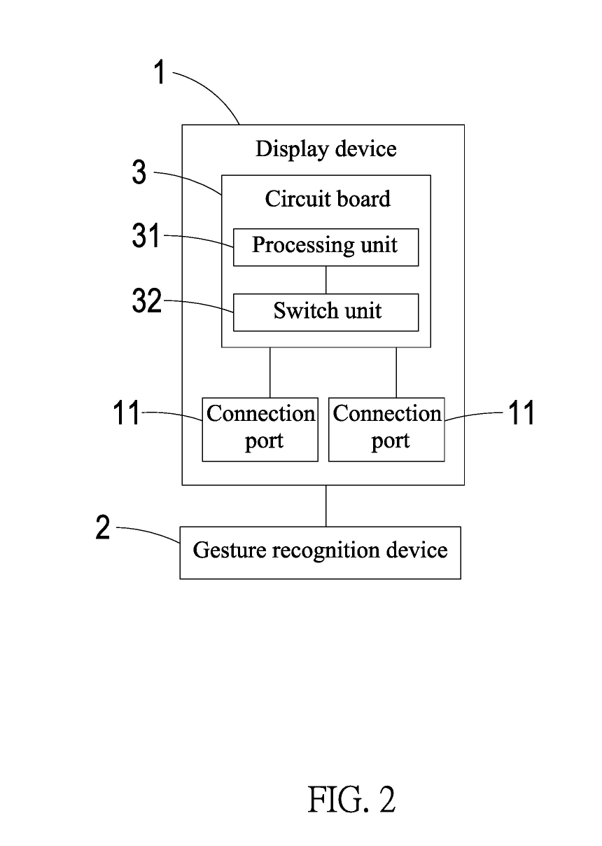

As shown in FIGS. 1 and 2, a display system according to an embodiment of the present invention includes the following components.

There is a display device 1.

At least a gesture recognition device 2 is configured along an edge of the display device 1. The gesture recognition device 2 may be a touch panel recognizing written gestures on the touch panel, or an image capturing device recognizing hand gestures drawn in the air.

A number of connection ports 11 are configured also along an edge of the display device 1, each connecting a computer and receiving video signal from the computer for presentation on the display device 1.

A circuit board 3 is housed inside the display device 1 and data-linked with the connection ports 11 and the gesture recognition device 2. The circuit board 3 includes a processing unit 31 and a switch unit 32. The processing unit 31 includes a processor and a memory (e.g., RAM). As such, a gesture is recognized by the gesture recognition device 2 and the switch unit 32 is controlled to select the video signal from a specific connection port 11 to be presented by the display device 1.

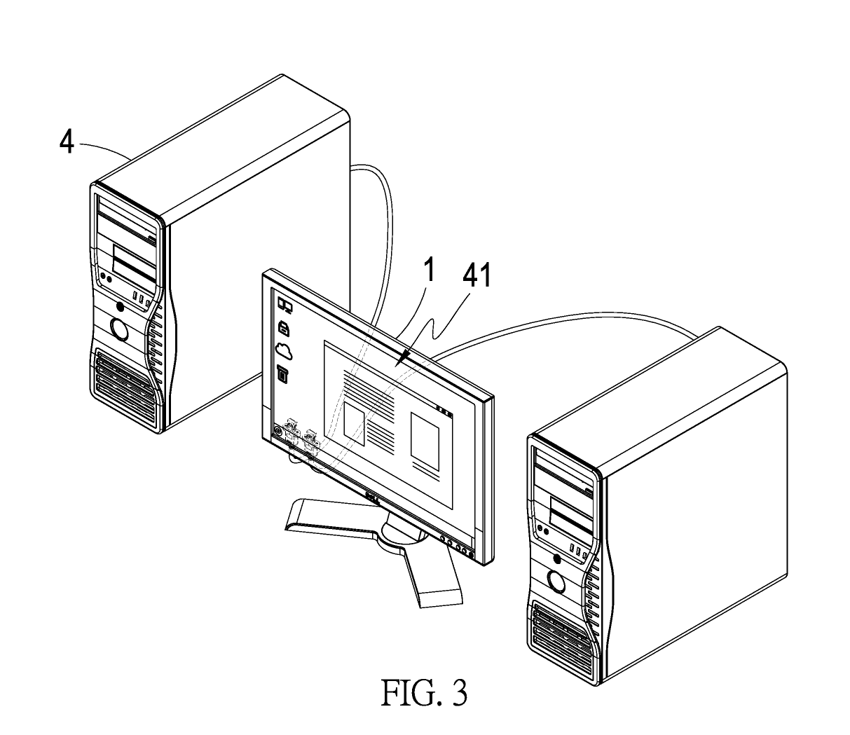

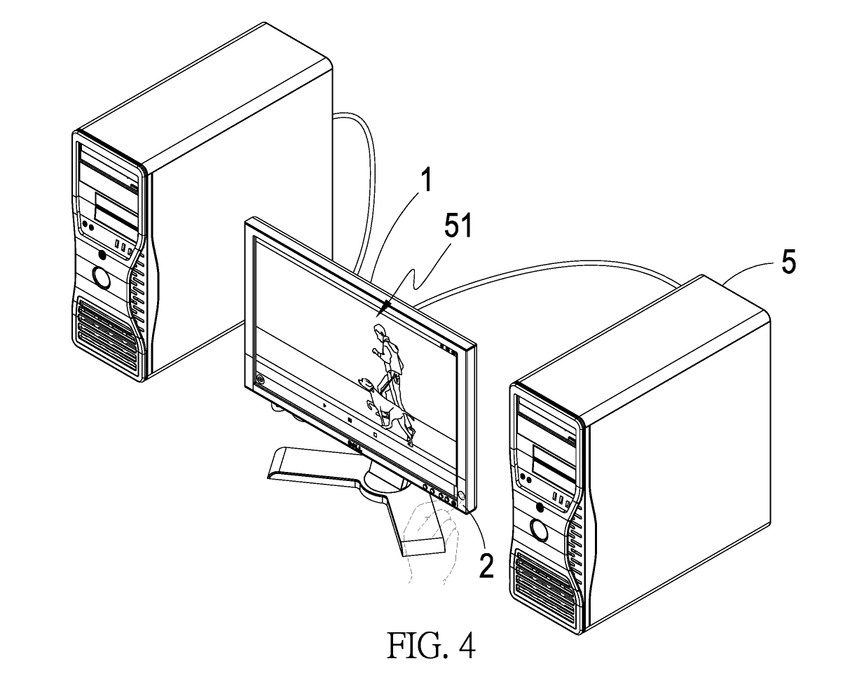

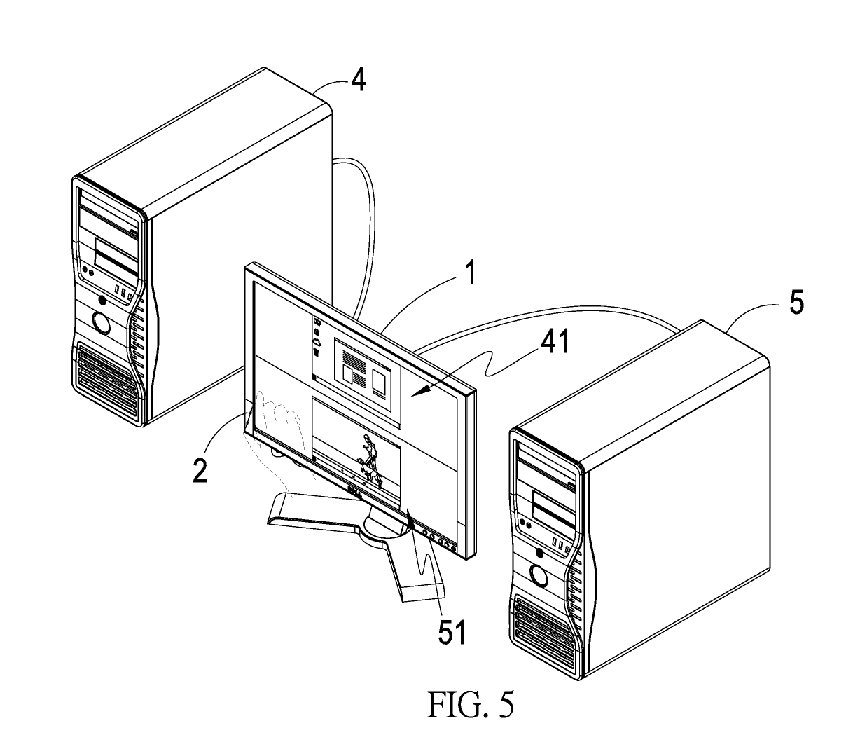

As shown in FIGS. 3 to 5, the connection ports 11 are connected to a first computer 4 and a second computer 5, respectively. The display device 1 currently presents a first image 41 from the first computer 4's video signal. To show the second computer 5's video signal on the display device 1, a written gesture or a hand gesture in the air (such as twisting the fingers) is recognized by the gesture recognition device 2, and a message is delivered to the processing unit 31. Based on the command embedded in the message, the processing unit 31 instructs the switch unit 32 to select the video signal from the second computer 5. Therefore an image 51 is then presented from the second computer 5's video signal. To simultaneously show the video signals of the first and second computers 4 and 5 on the display device 1, another touch gesture or hand gesture in the air (such as twisting the fingers in a different manner) is recognized by the gesture recognition device 2, and another message is delivered to the processing unit 31. Based on the command embedded in the message, the processing unit 31 instructs the switch unit 32 to combine the video signals from the first and second computers 4 and 5, for example, in a split-screen manner. Therefore both images 41 and 51 are then presented on the display device 1. Additionally, a different gesture may be used in a similar way to control that the first and second images 41 and 51 are presented in a horizontally or vertically split-screen manner.

Furthermore, the processing unit 31 may assist the display of the video signals from the first and second computers 4 and 5. Therefore, even though the first and second computers 4 and 5 may be too busy to process their respective video signal smoothly. The processing unit 31 may assist the buffering of these video signals so that they can still be presented on the display device 1 smoothly without being delayed by the busy first and second computers 4 and 5.

Compared to the prior art, the present invention has the following advantages.

Firstly, by using simple gestures, a user can conveniently share a single device among multiple computers and achieve the switching of the display among these computers.

Secondly, the processing unit 31 can effectively reduce the overhead of the computers so that the smoothness of the display from these computers is enhanced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A display system shared among a plurality of computers, comprising
a display device;
at least a gesture recognition device configured along an edge of the display device;
a plurality of connection ports configured along an edge of the display device, each connecting one of the computer and receiving video signal from the computer for presentation on the display device; and
a circuit board housed inside the display device and data-linked with the connection ports and the gesture recognition device, where the circuit board comprises a processing unit and a switch unit;
wherein a gesture is recognized by the gesture recognition device and the switch unit is controlled to select a video signal from a specific connection port to be presented by the display device.

2. The display system according to claim 1, wherein the processing unit comprises a processor.

3. The display system according to claim 1, wherein the processing unit comprises a memory.

4. The display system according to claim 1, wherein the gesture recognition device is a touch panel recognizing written gestures on the touch panel, or an image capturing device recognizing hand gestures drawn in the air.
